(19) United States
(12) Patent Application Publication
(10) Pub. No.: US 2015/0373128 A1
(43) Pub. Date: Dec. 24, 2015

(54) AUTOMATIC DISCOVERY AND DOWNLOAD OF APPLICATION BASED ON LOCATION

(71) Applicant: Kobo Incorporated, Toronto (CA)

(72) Inventor: Michael M. Serbinis, Toronto (CA)

(21) Appl. No.: 14/310,414

(22) Filed: Jun. 20, 2014

(51) Int. Cl. H04L 29/08; H04W 4/02

(52) U.S. Cl. CPC H04L 67/18; H04L 67/16; H04L 67/1021; H04L 67/34; H04W 4/028

(57) ABSTRACT

In accordance with a first method embodiment of the present invention, a computer implemented method includes determining a location of a hand held computer system and responsive to the determining, downloading an application program specific for the location to the hand held computer system. The method may also include sending first information of the location to a second computer system and receiving, from the second computer system, the application program specific for the location. The method may further include sending second information identifying the hand held computer system to the second computer system and receiving, from the second computer system, the application program specific for the location, wherein the application program reflects a preference history of the hand held computer system.

### RELATED CASE

This application is related to commonly owned U.S. patent application Ser. No. ______, attorney docket KOBO-0051, filed Jun. 20, 2014, entitled “Automatic Discovery and Download of Media Content Based on Location” to Servinis, which is hereby incorporated herein by reference in its entirety.

### FIELD OF INVENTION

Embodiments of the present invention relate to the field of location aware applications. More specifically, embodiments of the present invention relate to systems and methods for automatic discovery and download of application(s) based on location.

### BACKGROUND

Electronic devices, e.g., smart phones, tablet computers, e-readers and the like, are ubiquitous. Such devices are almost always with their users wherever such users travel, and should provide information and services based on their location.

### SUMMARY OF THE INVENTION

Therefore, what is needed are systems and methods for automatic discovery and download of application(s) based on location. What is additionally needed are systems and methods for automatic discovery and download of application(s) based on location that take into account a user's preference history. A further need exists for systems and methods for automatic discovery and download of application(s) based on location that are compatible and complementary with existing systems and methods of electronic books, including sales of such electronic books. Embodiments of the present invention provide these advantages.

In accordance with a first method embodiment of the present invention, a computer implemented method includes determining a location of a hand held computer system and responsive to the determining, downloading an application program specific for the location to the hand held computer system. The method may also include sending first information of the location to a second computer system and receiving, from the second computer system, the application program specific for the location. The method may further include sending second information identifying the hand held computer system to the second computer system and receiving, from the second computer system, the application program specific for the location, wherein the application program reflects a preference history of the hand held computer system.

In accordance with another embodiment the present invention, an article of manufacture includes a computer readable medium having instructions stored thereon that, responsive to execution by an electronic system, cause the electronic system to perform operations including determining a location of a hand held computer system and responsive to the determining, downloading an application program specific for the location to the hand held computer system. The operations may also include sending first information of the location to a second computer system and receiving, from the second computer system, the application program specific for the location. The operations may further include sending second information identifying the hand held computer system to the second computer system and receiving, from the second computer system, the application program specific for the location, wherein the application program reflects a preference history of the hand held computer system.

In accordance with a further embodiment the present invention, an electronic system includes one or more processors, a memory coupled to the one or more processors, wherein the memory is configured to accept and store at least one application program, and a wireless communications port coupled to the one or more processors configured to send and receive computer information via a wireless network. The electronic system is configured to determine a location of a hand held computer system and responsive to the determining, download an application program specific for the location to the electronic system.

### BRIEF DESCRIPTION OF THE DRAWINGS

The accompanying drawings, which are incorporated in and form a part of this specification, illustrate embodiments of the invention and, together with the description, serve to explain the principles of the invention. Unless otherwise noted, the drawings are not drawn to scale.

FIG. 1 illustrates an exemplary scenario for operation of embodiments in accordance with the present invention.

FIG. 2A illustrates an exemplary graphical user interface, in accordance with embodiments of the present invention.

FIG. 2B illustrates an exemplary graphical user interface, in accordance with embodiments of the present invention.

FIG. 3 illustrates an exemplary method, in accordance with embodiments of the present invention.

FIG. 4 illustrates an exemplary block diagram of an exemplary electronic system, which may be used as a platform to implement embodiments of the present invention.

### DETAILED DESCRIPTION

Reference will now be made in detail to various embodiments of the present invention, examples of which are illustrated in the accompanying drawings. While the invention will be described in conjunction with these embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. However, it will be recognized by one of ordinary skill in the art that the invention may be practiced without these specific details. In other instances, well known methods, procedures, components, and circuits have not been described in detail as not to unnecessarily obscure aspects of the invention.

### NOTATION AND NOMENCLATURE

Some portions of the detailed descriptions which follow (e.g., method 300) are presented in terms of procedures, steps, logic blocks, processing, and other symbolic representations of operations on data bits that may be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “sending” or “receiving” or “creating” or “downloading” or “displaying” or “detecting” or “determining” or “setting” or “accessing” or “placing” or “testing” or “forming” or “mounting” or “removing” or “ceasing” or “stopping” or “coating” or “processing” or “performing” or “generating” or “adjusting” or “creating” or “executing” or “continuing” or “indexing” or “translating” or “calculating” or “measuring” or “gathering” or “running” or the like, refer to the action and processes of, or under the control of, a computer system, or similar electronic computing device, that manipulates and transforms data represented as physical (electronic) quantities within the computer system's registers and memories into other data similarly represented as physical quantities within the computer system memories or registers or other such information storage, transmission or display devices.

As used herein, the term “location” may refer to both geographic location, e.g., “in Paris,” “at a particular latitude and longitude,” and/or to a functional description of location, e.g., “at Dr. Hughes' office” or “in a (specific) toy store.”

### Automatic Discovery and Download of Application Based on Location

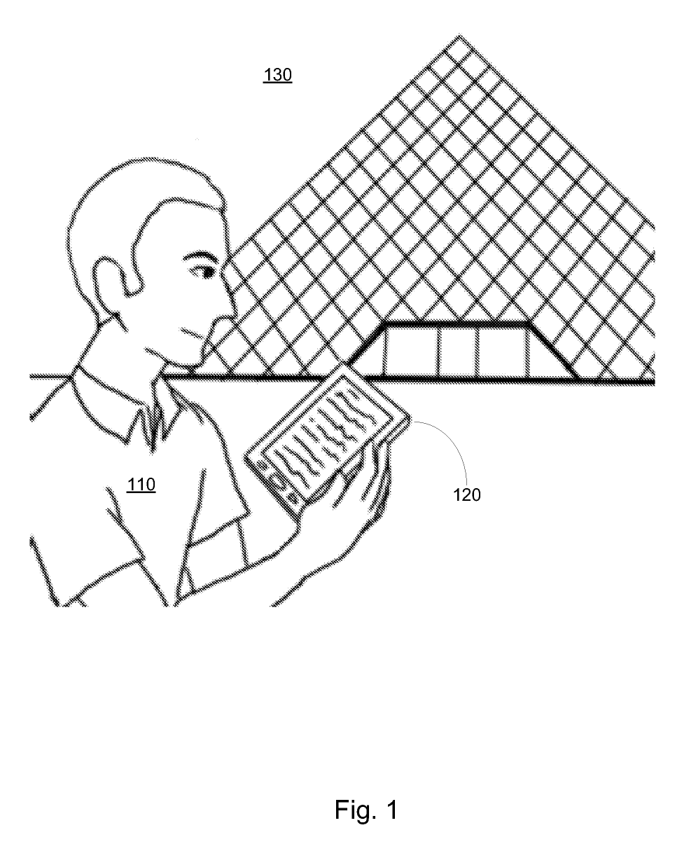

FIG. 1 illustrates an exemplary scenario for operation of embodiments in accordance with the present invention. As illustrated in FIG. 1, a user 110 operates a hand held computer system 120, for example, an e-reader, mobile phone, tablet or the like, at a geographic location 130, for example, near the entrance to the Louvre Museum in Paris, France.

Hand held computer system 120 comprises one or more location determining features. For example, hand held computer system 120 may determine its position by use of a Global Positioning System (GPS), including, for example, the planned European Union Galileo positioning system, India's Indian Regional Navigational Satellite System and/or the Chinese Compass navigation system. Hand held computer system 120 may also determine its position via a mobile telephone network, for example, measuring signal strength and/or triangulation of cell towers. Hand held computer system 120 may also determine its position from known locations of wireless networks, e.g., WiFi hotspots, or any other applicable location service(s).

The user 110 need not take any specific actions, e.g., manipulate or otherwise operate hand held computer system 120, in order for embodiments in accordance with the present invention to function. For example, such embodiments may operate automatically, without intervention from user 110.

Responsive to such location information, hand held computer system 120 presents user 110 with a list of media content, e.g., e-books, e-magazines, audio and/or audio/visual media content and the like, that may be of interest to user 110 at the particular location. For example, when at the Louvre Museum, the suggested media content may include an electronic museum guide, which may include audio and/or video media content. The museum guide may be published by the museum, or by other parties in competition with the museum, e.g., by agreement with the device manufacturer.

In accordance with embodiments of the present invention, a media content suggestion may comprise a recommendation to download an application or “app.” Such an application may comprise an e-reader application, e.g., the “Kobo” app, commercially available from Kobo Inc., of Toronto, Canada. The application may be a general purpose version of such application, or it may be customized for the location. For example, responsive to a determination of being located in a doctor's office, a user may be presented with a suggestion to download an “e-Magazine” application, which offers access to a variety of electronic magazines. As another example, responsive to a determination of being located in a toy store, a user may be presented with a suggestion to download a specialized app, for example the “Babies ‘R’ Us” Guide App, and/or the “Toy Guide” app, commercially available from TOYS“R”US, Inc., of Wayne, N.J.

The media content or application program suggestions may include other media with a different association with the geographic location. For example, when at the Louvre Museum, the suggested media content may include, for example, more general guides to Paris, or novels or movies having settings at the Louvre or dealing with the Louvre's history.

In accordance with embodiments of the present invention, media content suggestions may use a user's interests, e.g., a user's purchasing, reading and/or browsing history. For example, if user 110 has shown an interest in the French Revolution, media content suggestions may be adjusted, e.g., limited or expanded, to include material on this conflict or period. For example, the media content suggestions presented on hand held computer system 120 while at or near the Louvre may highlight portions of the Louvre's collection focusing on the French Revolution. Any suitable systems of suggesting media to a user may be combined with location information to generate location-enhanced media content suggestions, in accordance with embodiments of the present invention.

In accordance with embodiments of the present invention, media content suggestions may take into account a user's location history. For example, for a user 110 located at Paris's airport, a Paris and/or France guidebook may be more a more appropriate media content suggestion if the user 110 has just arrived in Paris, as opposed to having been in Paris for several days, and likely is departing. Hand held computer system 120 may determine arrival versus departure, for example, by comparing recent locations to a present location.

In accordance with embodiments of the present invention, media content suggestions may reflect a nature of a user's location. For example, if the user 110 is near or in a quick service restaurant, the hand held computer system 120 may present media content suggestions related to that restaurant, e.g., menu items, nutritional information, and the like. Such offerings may include stories, e.g., directed at children, featuring toys and/or characters associated with the restaurant. Such media content suggestions or offerings, e.g., a song or an illustrated story, may replace or supplement toys included with children's meals, in accordance with embodiments of the present invention.

Similarly, if in or near a toy store, the hand held computer system 120 may present media content suggestions related to that establishment, e.g., sales flyers, store layout and the like. Many toys have associated media content, e.g., action figures and movies featuring such figures. Media content suggestions may include written and/or audio/visual media related to toys sold at the toy store. For example, a media content suggestion may include an offer to download a movie featuring an action figure, e.g., at a discounted cost with purchase of the action figure.

As another example, if the user 110 is at a dentist's office, the hand held computer system 120 may present media content suggestions appropriate to such an office, e.g., magazines to help pass the time while waiting. In accordance with embodiments of the present invention, hand held computer system 120 may present media content suggestions related to a dentist's services. For example, a media content suggestion may include information related to cosmetic services, e.g., teeth whitening, offered by a dentist, e.g., an informational brochure.

Another exemplary location for operation of embodiments in accordance with the present invention is at transportation nodes, e.g., airports, rail stations and the like. Media content and/or application program suggestions may include “waiting” material, e.g., e-magazines or an e-magazine app, travel guides, transit schedules, navigation software, geocaching software, or any suitable media content or application software that may enhance the enjoyment or productivity of user 110 at the present location.

In accordance with some embodiments of the present invention, media content suggestions may always comprise more than one suggested media.

It is to be appreciated that, in accordance with embodiments of the present invention, media content suggestions are based upon location, either geographical and/or functional, and not on the presence or availability of a particular network, e.g., a WiFi network. For example, media content suggestions may be made in the absence of a wireless local area network (LAN).

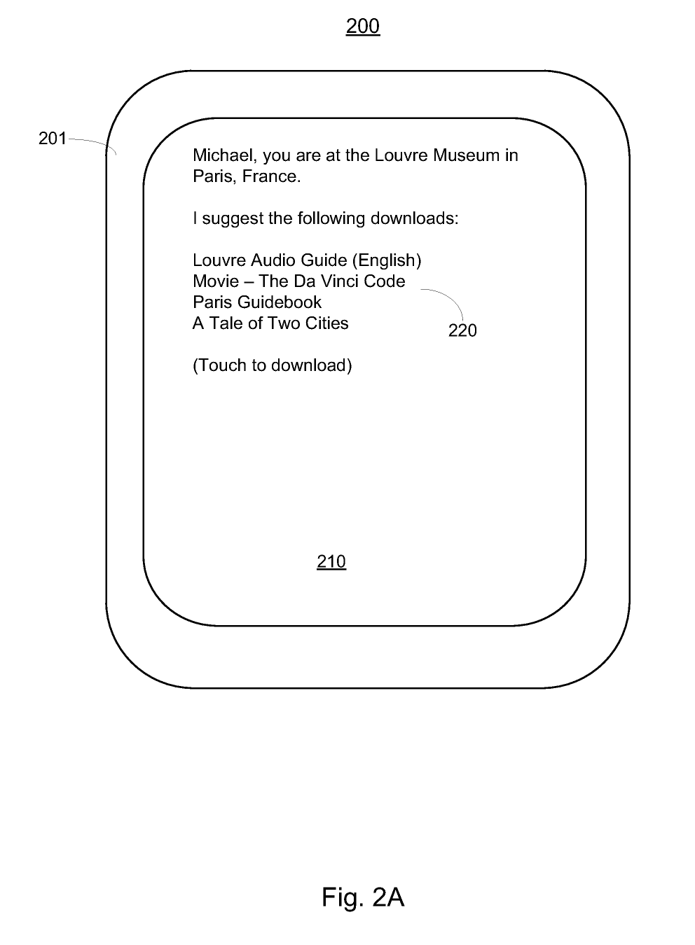

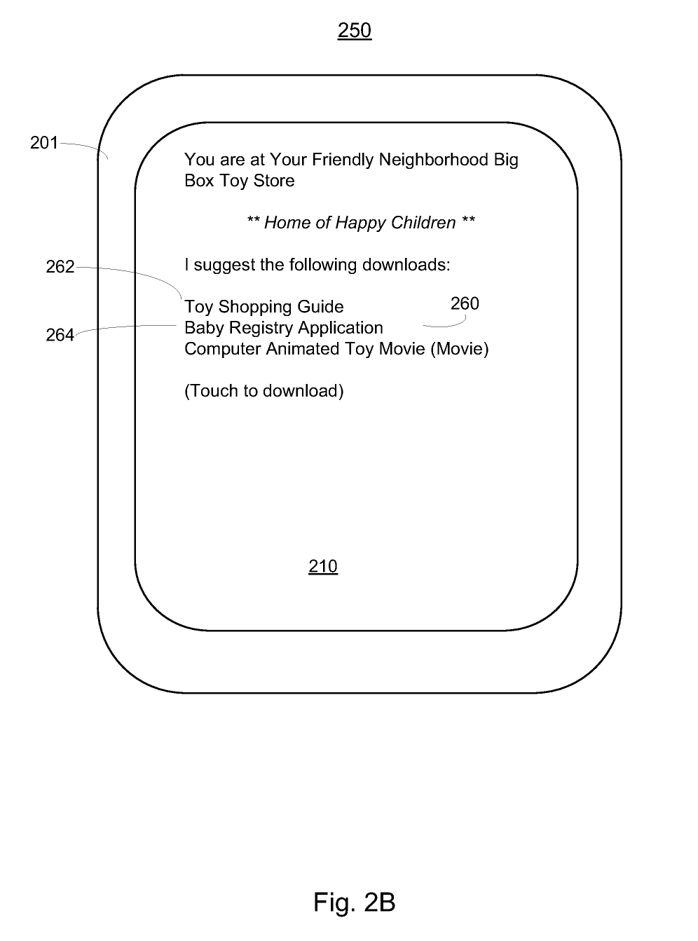

FIG. 2A illustrates an exemplary graphical user interface 200, in accordance with embodiments of the present invention. Graphical user interface 200 is presented on a display 210 of hand held computer system 201, which may correspond to hand held computer system 120 of FIG. 1. Responsive to location information, hand held computer system 201 presents a user, e.g., user 110 of FIG. 1, with a list 220 of media content suggestions for download. The media may be free or require payment for download, in some embodiments. In some embodiments, the media may only be available, or may be available at a discount, when the user and computer system are in a specific location. In some embodiments, access to the media may terminate when the user departs the specific location. For example, even if a media was downloaded onto the hand held computer system 201, access or operation of the media may be keyed to a specific location, and the media may not be accessible outside of such location.

FIG. 2B illustrates an exemplary graphical user interface 250, in accordance with embodiments of the present invention. Graphical user interface 250 is presented on a display 210 of hand held computer system 201. Responsive to location information, hand held computer system 201 presents a user, e.g., user 110 of FIG. 1, with a list 260 of media content suggestions for download. It is appreciated that items 262 and 264 are application programs, or “apps.” The media and/or apps may be free or require payment for download, in some embodiments. In some embodiments, the media may only be available, or may be available at a discount, when the user and computer system are in a specific location. In some embodiments, access to the app may terminate when the user departs the specific location. For example, even if an app was loaded onto the hand held computer system 201, access or operation of the app may be keyed to a specific location, and the app may not be accessible outside of such location.

In accordance with embodiments of the present invention, media content and/or apps may be automatically downloaded responsive to a specific location. For example, responsive to a determination of a specific location, hand held computer system 201 automatically downloads and/or initiates such download, e.g., opens an e-magazine and/or runs an application program, without requiring a user intervention.

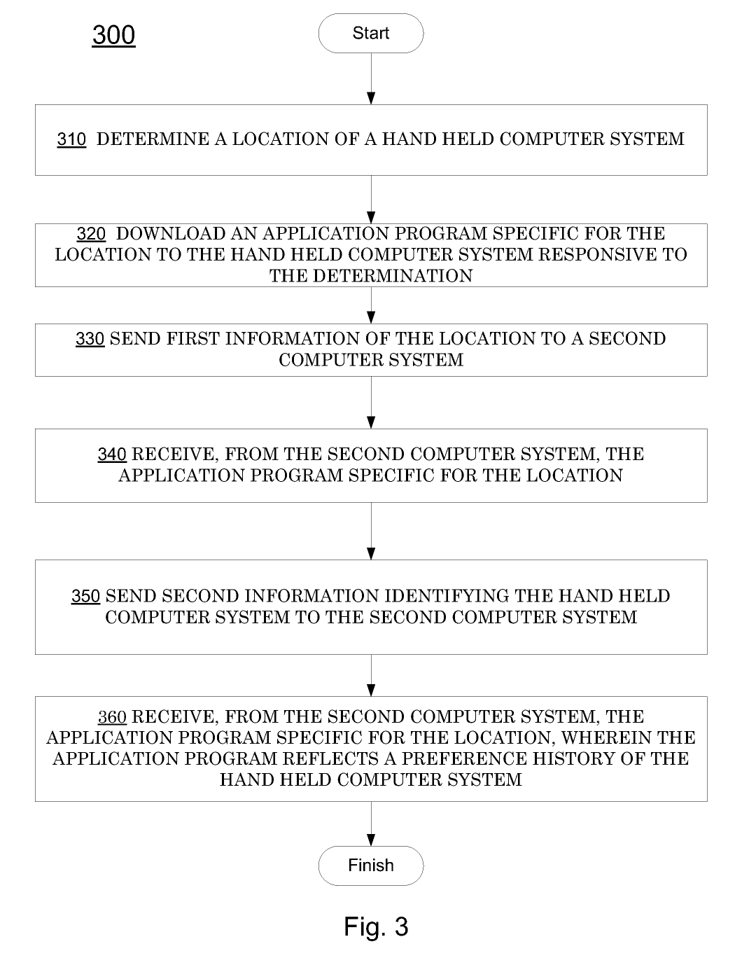

FIG. 3 illustrates an exemplary method 300, in accordance with embodiments of the present invention. In 310, a location of a hand held computer system is determined. Any suitable system for determining location is suitable for use with embodiments in accordance with the present invention. For example, hand held computer system 120 (FIG. 1) may determine its position by use of a Global Positioning System (GPS). Hand held computer system 120 may also determine its position via a mobile telephone network, for example, measuring signal strength and/or triangulation of cell towers. Hand held computer system 120 may also determine its position from known locations of wireless networks, e.g., WiFi hotspots, or any other applicable location service(s). The location may be a geographic location or a functional location, e.g., identify a specific business. In accordance with embodiments of the present invention, the application program may be determined based on a location history. The application program may be initiated without intervention by a user of said hand held computer system. The application program may present at least two suggested media files for download onto said hand held computer system.

In 320, responsive to the location determination, an application program specific for said location to the hand held computer system. In optional 330, first information of the location is sent to a second computer system, e.g., via a wireless network. In optional 340, the application program specific for said location is received from the second computer system.

In optional 350, second information identifying said hand held computer system is sent to the second computer system. In optional 360, the application program specific for said location is received from the second computer system. The application program reflects a preference history of the hand held computer system.

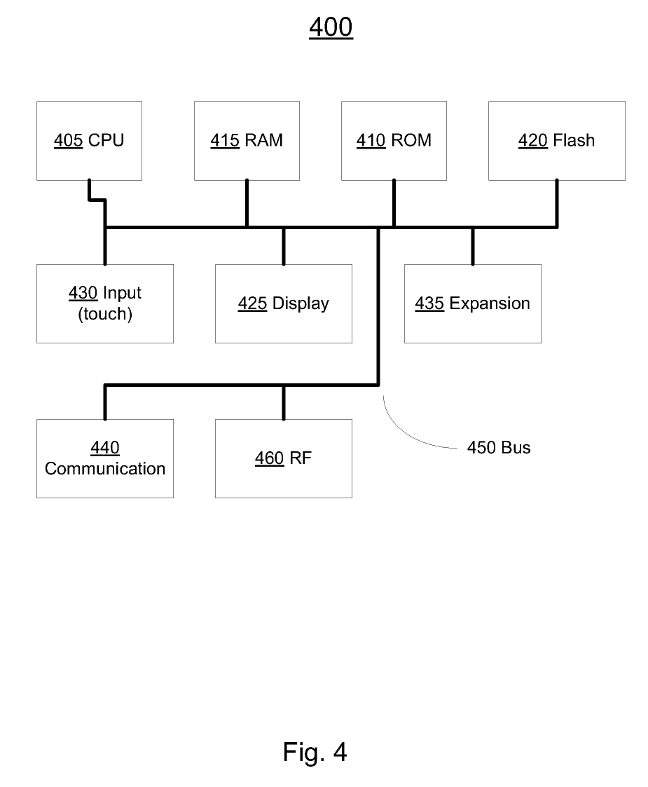

FIG. 4 illustrates an exemplary block diagram of an exemplary electronic system 400, which may be used as a platform to implement embodiments of the present invention. Electronic system 400 may be a basis for hand held computer system 120 of FIG. 1 and/or hand held computer system 201 of FIG. 2A. Electronic system 400 may be battery-powered, in some embodiments. In some embodiments, electronic system 400 may be a “server” computer. Electronic system 400 includes an address/data bus 450 for communicating information, a central processor 405 functionally coupled with the bus for processing information and instructions. Central processor 405 may comprise multiple processors, e.g., a multi-core processor, or multiple separate processors, in some embodiments. Electronic system 400 also includes a volatile memory 415 (e.g., random access memory RAM) coupled with the bus 450 for storing information and instructions for the central processor 405, and a non-volatile memory 410 (e.g., read only memory ROM) coupled with the bus 450 for storing static information and instructions for the processor 405. Electronic system 400 also optionally includes a changeable, non-volatile memory 420 (e.g., flash) for storing information and instructions for the central processor 405 which can be updated after the manufacture of system 400. In some embodiments, only one of ROM 410 or Flash 420 may be present.

Also included in electronic system 400 of FIG. 4 is an optional input device 430. Device 430 can communicate information and command selections to the central processor 400. Input device 430 may be any suitable device for communicating information and/or commands to the electronic system 400. For example, input device 430 may take the form of a keyboard, buttons, a joystick, a track ball, an audio transducer, e.g., a microphone, a touch sensitive digitizer panel, eyeball scanner and/or the like. A touch sensitive digitizer panel may comprise any suitable technology, e.g., capacitive, resistive, optical, acoustic and/or pressure responsive touch panels. Activation of a “touch” sensitive digitizer panel may not require actual touching of the panel 430 or the Electronic system 400, in some embodiments. For example, capacitive touch panels may sense proximity of a user's finger or an eyeball scanner may detect a direction of a user's gaze.

The display unit 425 utilized with the electronic system 400 may comprise a liquid crystal display (LCD) device, cathode ray tube (CRT), field emission device (FED, also called flat panel CRT), light emitting diode (LED), plasma display device, electro-luminescent display, electronic paper, electronic ink (e-ink) or other display device suitable for creating graphic images and/or alphanumeric characters recognizable to the user. Display unit 425 may have an associated lighting device, in some embodiments. Display unit 425 may comprise a head-mounted display, in some embodiments.

A touch sensitive digitizer panel 430 is generally associated with the display unit 425. For example, a function of the touch sensitive digitizer panel 430 generally associated with the display unit 425 is to localize a touch input, e.g., from a finger or stylus, to a portion of display unit 425, for example, a single icon image displayed on display unit 425. The touch sensitive digitizer panel may be in front of the actual display device, e.g., in a viewer's optical path, or the touch sensitive digitizer panel may be outside of a viewer's optical path, e.g., behind or to the side of the display device. The touch sensitive digitizer panel 430 may have different planar dimensions in comparison to planar dimensions of a display unit 425. For example, the touch sensitive digitizer panel 430 may be smaller than display unit 425, e.g., the display unit 425 may extend beyond the touch sensitive digitizer panel 430. Similarly, the touch sensitive digitizer panel 430 may be larger than display unit 425, e.g., the touch panel may extend beyond the display unit. The touch sensitive digitizer panel may be integral to a display assembly, or a separate assembly within the electronic system 400. A touch sensitive digitizer panel is not required.

Electronic system 400 also optionally includes an expansion interface 435 coupled with the bus 450. Expansion interface 435 can implement many well known standard expansion interfaces, including without limitation the Secure Digital Card interface, universal serial bus (USB) interface, Compact Flash, Personal Computer (PC) Card interface, CardBus, Peripheral Component Interconnect (PCI) interface, Peripheral Component Interconnect Express(PCI Express), mini-PCI interface, IEEE 1394, Small Computer System Interface (SCSI), Personal Computer Memory Card International Association (PCMCIA) interface, Industry Standard Architecture (ISA) interface, RS-232 interface, and/or the like. In some embodiments of the present invention, expansion interface 435 may consist of signals substantially compliant with the signals of bus 450.

A wide variety of well known devices may be attached to electronic system 400 via the bus 450 and/or expansion interface 435. Examples of such devices include without limitation rotating magnetic memory devices, flash memory devices, digital cameras, wireless communication modules, digital audio players and Global Positioning System (GPS) devices.

System 400 also optionally includes a communication port 440. Communication port 440 may be implemented as part of expansion interface 435. When implemented as a separate interface, communication port 440 may typically be used to exchange information with other devices via communication-oriented data transfer protocols. Examples of communication ports include without limitation RS-232 ports, universal asynchronous receiver transmitters (UARTs), USB ports, infrared light transceivers, ethernet ports, IEEE 1394 and synchronous ports.

System 400 optionally includes a radio frequency module 460, which may implement a mobile telephone, a wireless network, e.g., IEEE 802.11 (“Wi-Fi”), Bluetooth, a pager, or a digital data link. Radio frequency module 460 may be interfaced directly to bus 450, via communication port 440, via expansion interface 435, or any suitable interface. Various features of electronic system 400 may be implemented by a combination of hardware and/or software. Electronic system 400 may comprise additional software and/or hardware features (not shown) in some embodiments.

Various modules of system 400 may access computer readable media, and the term is known or understood to include removable media, for example, Secure Digital (“SD”) cards, CD and/or DVD ROMs, diskettes and the like, as well as non-removable or internal media, for example, hard drives, RAM, ROM, flash, and the like.

Embodiments in accordance with the present invention provide systems and methods for automatic discovery and download of application(s) based on location. In addition, embodiments in accordance with the present invention provide systems and methods for automatic discovery and download of application(s) based on location that take into account a user's preference history. Further, embodiments in accordance with the present invention provide systems and methods for automatic discovery and download of application(s) based on location that are compatible and complementary with existing systems and methods of electronic books, including sales of such electronic books.

Various embodiments of the invention are thus described. While the present invention has been described in particular embodiments, it should be appreciated that the invention should not be construed as limited by such embodiments, but rather construed according to the below claims.

What is claimed is:

1. A computer implemented method comprising:
determining a location of a hand held computer system; and
responsive to said determining, downloading an application program specific for said location to said hand held computer system.

2. The computer implemented method of claim 1 further comprising:
sending first information of said location to a second computer system; and
receiving, from said second computer system, said application program specific for said location.

3. The computer implemented method of claim 2 further comprising:
sending second information identifying said hand held computer system to said second computer system; and
receiving, from said second computer system, said application program specific for said location, wherein said application program reflects a preference history of said hand held computer system.

4. The computer implemented method of claim 1 wherein said determining identifies a geographic location.

5. The computer implemented method of claim 1 wherein said determining identifies a specific business.

6. The computer implemented method of claim 1 wherein said application program is determined based on a location history.

7. The computer implemented method of claim 1 wherein said application program is initiated without intervention by a user of said hand held computer system.

8. The computer implemented method of claim 1 wherein said application program presents at least two suggested media files for download onto said hand held computer system.

9. An article of manufacture including a computer readable medium having instructions stored thereon that, responsive to execution by an electronic system, cause said electronic system to perform operations comprising:
determining a location of a hand held computer system; and
responsive to said determining, downloading an application program specific for said location to said hand held computer system.

10. The article of manufacture of claim 9 wherein said operations further comprise:
sending first information of said location to a second computer system;
sending second information identifying said hand held computer system to said second computer system; and
receiving, from said second computer system, said application program specific for said location, wherein said application program reflects a preference history of said hand held computer system.

11. The article of manufacture of claim 9 wherein said determining identifies a geographic location.

12. The article of manufacture of claim 9 wherein said determining identifies a specific business.

13. The article of manufacture of claim 9 wherein said application program is determined based on a location history.

14. The article of manufacture of claim 9 wherein said application program presents at least two suggested media files for download onto said hand held computer system.

15. An electronic system comprising:
one or more processors;
a memory coupled to said one or more processors, wherein said memory is configured to accept and store at least one application program;
a wireless communications port coupled to said one or more processors configured to send and receive computer information via a wireless network;
wherein said electronic system is configured to:
determine a location of a hand held computer system; and
responsive to said determining, download an application program specific for said location to said electronic system.

16. The electronic system of claim 15 further configured to:
sending first information of said location to a second computer system via said wireless network;
sending second information identifying said hand held computer system to said second computer system via said wireless network; and
receiving, from said second computer system via said wireless network, said application program specific for said location, wherein said application program reflects a preference history of said hand held computer system.

17. The electronic system of claim 15 wherein said location is a geographic location.

18. The electronic system of claim 15 wherein said location is a specific business.

19. The electronic system of claim 15 further configured to:
initiate said application program on said electronic system without user intervention.

20. The electronic system of claim 15 wherein said application program is configured to present at least two suggested media files for download onto said hand held computer system.
